(19) United States
(12) Patent Application Publication
(10) Pub. No.: US 2005/0108748 A1
(43) Pub. Date: May 19, 2005

(54) Display filter criteria and results display apparatus and method

(75) Inventors: Yuko Nishikawa, La Jolla, CA (US); Dayan Golden, San Diego, CA (US); Michael A. Bergeron, Poway, CA (US); Himgan Wibisono, San Francisco, CA (US); Philip McKay, San Francisco, CA (US)

Correspondence Address: FITCH EVEN TABIN & FLANNERY, 120 SOUTH LASALLE SUITE 1600, CHICAGO, IL, 60603, US

(73) Assignees: Sony Corporation, a Japanese corporation, Tokyo (JP); Sony Electronics Inc., a Delaware corporation, Park Ridge, NJ (US)

(21) Appl. No.: 10/806,646

(22) Filed: Mar. 23, 2004

Related U.S. Application Data
(60) Provisional application No. 60/520,752, filed on Nov. 17, 2003.

(51) Int. Cl. H04N 7/173; G06F 13/00; H04N 5/445; H04N 7/16

(52) U.S. Cl. 725/38; 725/135; 725/37; 725/13

(57) ABSTRACT

Presently selected filter criterion for each of a plurality of characterizing descriptor filters are displayed along with characterizing descriptions of programming options that correspond to a present setting of the filters. A viewer readily navigates these displayed elements to discern available programming options and/or to view and select other filter criteria in an intuitive manner and without resort to nested menus. Upon moving an area of focus into a region of the display that includes a presently selected filter criterion, other user-selectable filter criteria for that filter are also automatically displayed to permit the viewer to observe, consider, and select a new criterion by which to filter the available programming options.

### PROVISIONAL APPLICATIONS

We claim the benefit of Provisional Patent Application No. 60/520,752, entitled “Ring Interface for TV Programming Guide” and as filed on Nov. 17, 2003.

### RELATED APPLICATIONS

This application relates to each of the following applications, each of which is commonly owned and was filed on an even date herewith and each of which is hereby incorporated by this reference:

3 DIMENSIONAL BROWSING AND SELECTION APPARATUS AND METHOD (attorney's docket number 81231);

INTERACTIVE PROGRAM GUIDE WITH PREFERRED ITEMS LIST APPARATUS AND METHOD (attorney's docket number 81233);

FILTER CRITERIA AND RESULTS DISPLAY APPARATUS AND METHOD (attorney's docket number 81205);

AUTOMATIC CONTENT DISPLAY APPARATUS AND METHOD (attorney's docket number 81232);

CANDIDATE DATA SELECTION AND DISPLAY APPARATUS AND METHOD (attorney's docket number 81229);

MULTI-SOURCE PROGRAMMING GUIDE APPARATUS AND METHOD (attorney's docket number 81235).

### TECHNICAL FIELD

This invention relates generally to information displays and more particularly to the use of display filters and displayed filter results for items of audio/visual content.

### BACKGROUND

Information displays of various kinds are essentially ubiquitous in modern society. Many such displays serve, at least in part, to present content options to a viewer. As the number, kind, and constitution of such content options expand, a concurrent challenge arises to facilitate a way to navigate such options in a manner that is helpful and meaningful to the viewer.

Interactive programming guides are an example of such challenges. With cable, fiber, and/or satellite broadband services facilitating the delivery of an increasing number of varied programming options at any given time, it becomes more important to present a viewer with useful and helpful interface mechanisms to permit the viewer to be informed regarding available content options as the sheer magnitude of programming options renders unlikely the possibility that the viewer will be otherwise sufficiently knowledgeable in this regard.

Present suggestions regarding interactive programming guides as used with various audio/visual content services often present a number of candidate programming options on a display. In some cases this display will include a short textual description of the content of one or more of the candidate programming options or other static information (such as a rating, a brief listing of key actors, a year of publication, and the like).

Display criteria filters are sometimes used to limit in some predetermined or selectable fashion the particular candidate programming options that are displayed. For example, a viewer may be offered the option to limit the displayable pool of programming options to only those options that are presently available for viewing. While helpful in some instances to facilitate the content selection process, such an approach does not meet the needs of all viewers under all viewing circumstances. For example, filter control often requires navigation of nested setting choices (which are often presented in a series of nested menus). Navigation of such a configuration to locate a desired setting opportunity can be both cumbersome and non-intuitive. Further, the navigation process itself, coupled with the loss of present on-screen data, can permit some viewers to lose their train of thought and hence stymie rather than facilitate the subjective process of selecting viewing material of interest to the viewer.

### BRIEF DESCRIPTION OF THE DRAWINGS

The above needs are at least partially met through provision of the display filter criteria and results display apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a display as configured in accordance with various embodiments of the invention;

FIG. 5 comprises a portion of a display as configured in accordance with various embodiments of the invention;

FIG. 6 comprises a display as configured in accordance with various embodiments of the invention;

FIG. 7 comprises a portion of a display as configured in accordance with various embodiments of the invention; and

FIG. 8 comprises a display as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, characterizing descriptors as individually correspond to a plurality of discrete selectable items of audio/visual content are provided. Two or more characterizing descriptor filters are also provided to permit and facilitate filtering of these characterizing descriptors. One then simultaneously displays a selected user-selectable characterizing descriptor filter criterion as corresponds to a first characterizing descriptor filter, a selected user-selectable characterizing descriptor filter criterion as corresponds to a second characterizing descriptor filter, and at least a portion of the characterizing descriptors as corresponds to these presently selected characterizing descriptor filter criterion.

In a preferred embodiment the characterizing descriptors comprise any of a variety of descriptors as may be relevant to a variety of audio/visual programs. Also in a preferred approach the user-selectable characterizing descriptor filter criterion as corresponds to the first characterizing descriptor filter is displayed in a segregated fashion with respect to the user-selectable characterizing descriptor filter criterion as corresponds to the second characterizing descriptor filter as well as the displayed characterizing descriptors. Similarly, the user-selectable characterizing descriptor filter criterion as corresponds to the second filter is displayed in a segregated fashion with respect to the user-selectable characterizing descriptor filter criterion as corresponds to the first characterizing descriptor filter as well as the displayed characterizing descriptors.

So configured, a viewer is provided with a clear and intuitive sense of what criteria are presently being used to filter all available viewing options to thereby determine the presently displayed set of viewing options. The viewer can readily navigate within the available displayed (or displayable) viewing options with little or no attendant confusion. Further, should the viewer wish to alter the filter criteria selections, navigation and interaction to effect such a change is again largely intuitive and relatively without confusion. In particular, such navigation requires only an intuitive application of on-screen highlighting/focus/cursor controls via, for example, a remote control as versus potentially more complicated and confusing nested menu navigation control interaction.

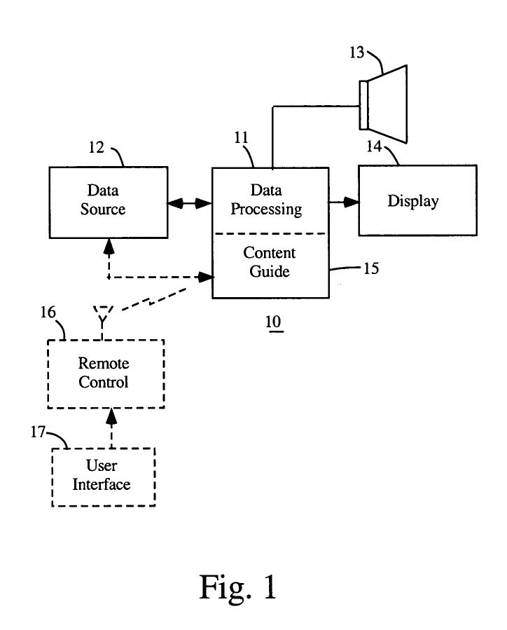

Referring now to the drawings, and in particular to FIG. 1, an apparatus 10 suitable to support and facilitate these teachings can comprise a data processing unit 11 that processes information from a data source 12 (or sources) and provides corresponding audio information to an audio processing path 13 and video information to a display 14.

The control circuitry of a data processing unit 11 can be embodied in a variety of ways. For example, the data processing unit 11 can comprise a fixed-purpose dedicated platform or can comprise a partially or fully programmable platform. Such options and architectural alternatives are well understood in the art and need no further elaboration here. In some embodiments, as with a so-called cable or satellite set-top box, the data processing unit 11 can be readily realized through appropriate programming of the processor as typically accompanies such an apparatus.

The data source 12 can comprise any presently known or hereafter developed data source. In a preferred embodiment the data source 12 provides audio/visual content such as television programs and movies. The data source 12 can provide access to wireless broadcast reception services, cable or optical fiber services, and/or satellite services, to name a few (either alone or in conjunction with one another). Depending upon the needs of the application, it is also possible that the data source 12 provides access to discrete selectable items of audio/visual content as are embodied in a plurality of media. For example, the data source 12 may provide access to cable programming options, satellite programming options, and local programming options as may be available via one or more local or otherwise available media drives (such as but not limited to video tape drives or digital video disk (DVD) drives). It is also possible that the data processing unit 11 operably couples to a plurality of such data sources to permit access to corresponding programming services and viewing options.

In a preferred embodiment this apparatus 10 further comprises a content guide 15. This content guide 15 can comprise an integral part of the data processing unit 11 (as suggested by the illustration in FIG. 1) or can comprise a physically separate platform that operably couples to the data processing unit 11. The content guide 15 can receive information regarding programming options in any of a variety of ways. For example, the data source 12 itself can source such information (either via the data processing unit 11 or directly via a dedicated coupling between itself and the content guide 15 engine). As another example, the content guide 15 can obtain such programming information in other ways such as via a dial-up link (not shown) that facilitates access to a server that provides such information.

In a preferred embodiment the content guide 15 further comprises two or more characterizing descriptor filters. The particular filters used can be selected as appropriate to the given needs and specific requirements of a given application. Some filter examples include, but are not limited to, a genre filter (with filter criteria such as “all,” “children's programming,” “comedy,” “drama,” “documentary,” “favorites list,” “service provider's recommendations,” “audio only,” and the like), a temporal filter (with filter criteria such as “now,” “upcoming within the next hour,” “tomorrow,” “previously recorded,” and the like), or a media/source filter (with filter criteria such as “broadcast television,” “satellite service 2,““cable service 1,” “Internet content,” “DVD bank 1,” “digital video recorder 3,” and the like). Through the use of such filters, an initial pool of candidate viewing choices can be reduced on the basis of the filter selection criteria as is generally well understood in the art. For example, by selecting a filter criterion of “now” for a first filter and a filter criterion of “children's” for a second filter, only presently viewable children's programming would be made available for selection browsing and navigation.

Such content guides are generally well understood in the art. The particular configuration and/or general operation of such engines is not especially important to these embodiments. Therefore additional detailed description will not be provided here regarding content guides except where appropriate below with respect to the description of these embodiments.

It will be understood that such apparatus 10 are often at least partially responsive to an optional wireless remote control 16. The latter often use infrared technology to facilitate communications but any wireless technology as may be appropriate to the needs of a given application can be utilized. In many instances such a remote control 16 will include a user interface 17 such as, for example, a keypad. Such a keypad will provide one or more keys that, when asserted by a user, will cause transmission of a particular corresponding wireless instruction by the remote control 16. Pursuant to a preferred embodiment, the operations of the content guide 15 will be at least partially configurable and/or otherwise controllable by appropriate remote control signals. Again, such remote controls are well understood in the art and require no further elaboration here.

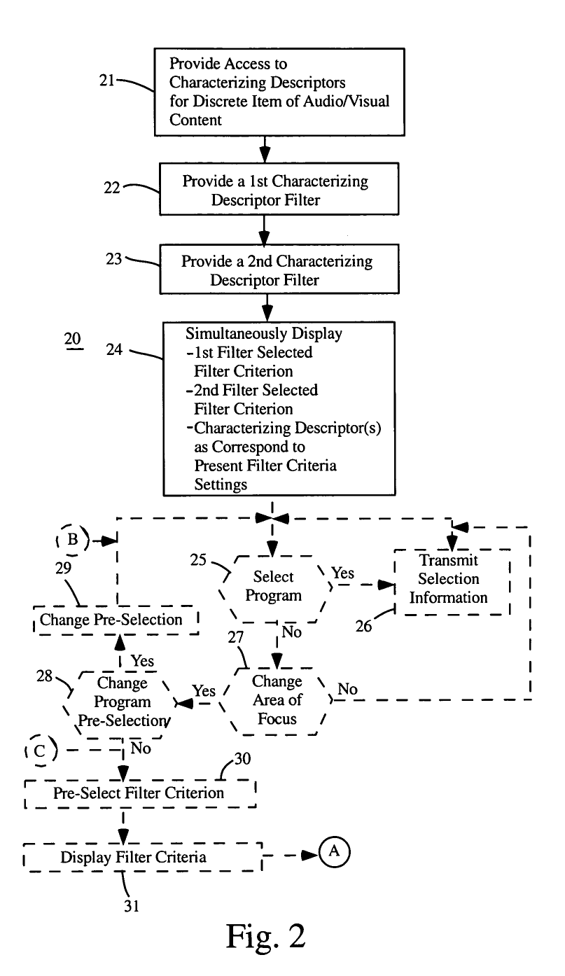

Referring now to FIG. 2, a process 20 that is readily supported by such an apparatus 10 (or that can be alternatively effected through any other suitable architectural configuration of choice) will be described. This process 20 provides for access 21 to characterizing descriptors as individually correspond to a plurality of discrete selectable items of audio/visual content (such as individual movies or television programs). The characterizing descriptors for such items of audio/visual content can be many and varied and can include, for example, a programming network identifier (such as the network call sign that will broadcast or otherwise source the particular program), a broadcast starting time (or stopping time) for the program, a description (such as a textual description) of (or that otherwise pertains to) the audio/visual work, and an indication of the content media source itself (such as whether the program is available by cable, satellite, local media, or the like). The characterizing descriptors can also include samples of the video (and/or audio content) of the item itself and/or a previously prepared trailer or other preview or promotional sample for the item. As already noted above, the individual items of audio/visual content can themselves be embodied in a plurality of media or can all stem from a common source as appropriate to individual circumstances.

At least two user-selectable characterizing descriptor filters are then provided 22 and 23. As noted above, such filters have filter criteria that pertain to one or more of the characterizing descriptors for the selectable items of data. To illustrate, such criteria can pertain to content genre, content availability, content rating, content source, cost of content access, language, presentation duration, and the like. While it might be useful in some application to have shared common criteria as between these two or more filters, in a preferred approach these filters will have mutually exclusive filter criteria sets. (The embodiments described below will presume for the ease of explanation and illustration that only two such user-selectable characterizing descriptor filters are so provided. It will be understood, however, that the invention is not so limited and that any number of additional filters can be added and used in a highly scalable fashion consistent with these teachings.)

Pursuant to one approach the two filters are provided independent of one another; that is, the provision 23 of the second characterizing filter occurs without specific regard for the selection of the first characterizing descriptor filter. If desired, however, the filters that are available for provision as the second filter and/or the specific characterizing descriptor filter criteria as are available for any given such filter can be made dependent upon the provision of the first characterizing descriptor filter. As one illustration of when the second filter might be restricted on the basis of the first filter type, when the first filter comprises a genre filter, it may be useful in some settings to exclude from consideration as a second filter a language filter. As another illustration of when the second filter might be restricted on the basis of the first filter type and its presently selected filter criterion, when the first filter comprises a genre filter and the presently selected filter criterion comprises “children,” it may be useful in some settings to exclude from consideration a second filter that specifies subtitling requirements.

As will be described below, specific characterizing descriptor filter criterion for each such filter can be selected in any of a variety of ways including, but not limited to, in response to navigation and selection instructions as received from a remote control device as described above.

This process 20 then provides for the simultaneous display 24 of a first selected user-selectable characterizing descriptor filter criterion as corresponds to a present setting of the first characterizing descriptor filter, a second selected user-selectable characterizing descriptor filter criterion as corresponds to a present setting of the second characterizing descriptor filter, and at least a portion of the characterizing descriptors for items of audio/visual content as correspond to the present setting of the first and second plurality of user-selectable characterizing descriptor filter criteria. In a preferred embodiment, this action further comprises not displaying any of the characterizing descriptors as do not correspond to the present setting of the first and second plurality of user-selectable characterizing descriptor filter criteria.

If desired, such a display of information can overlay the display of an item of audio/visual content (for example, a presently selected program can be displayed as a background image to the displayed information content). As another option, a currently selected program can be displayed as a windowed segregated image in combination with the information display provided by the above process 20.

In a preferred embodiment, the presently selected filter criterion for the first filter is displayed without a concurrent display of other presently unselected filter criteria for this first filter. The same can apply with respect to the selected filter criterion for the second filter.

To facilitate such steps, and referring now to FIG. 4, a display 14 can be segregated, for example, into three separated display areas. A first display area 41 can be reserved for the display of the selected user-selectable characterizing descriptor filter criterion as corresponds to the first characterizing descriptor filter. A second display area 42 can be reserved for the display of the selected user-selectable characterizing descriptor filter criterion as corresponds to the second characterizing descriptor filter. And the third display area 43 can be reserved for the display of the characterizing descriptors of the programming options as correspond to the present filter settings. Again, if desired, the entire display area (or some smaller subset) can also be used to simultaneously display a program of audio/visual content, such as a presently selected programming option, as a background to the filter criteria and characterizing descriptors.

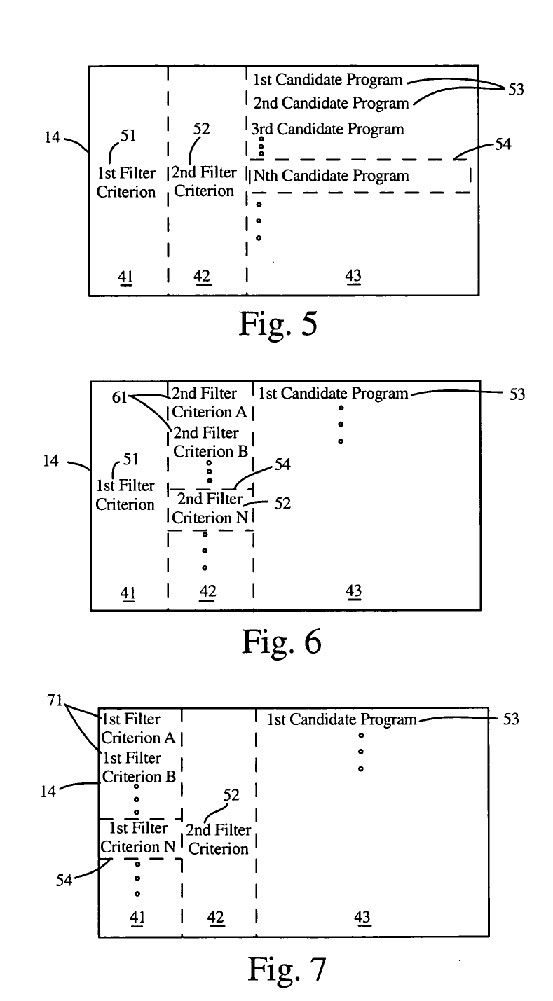

Referring now to FIG. 5, and in accord with the above teachings, the presently selected filter criterion 51 for the first characterizing descriptor filter can be displayed in the first display area 41. Similarly, the presently selected filter criterion 52 for the second characterizing descriptor filter can be simultaneously displayed in the second display area 42 while a plurality of resultant filtered characterizing descriptors 53 are simultaneously displayed in the third display area 43.

An area of focus 54 serves, in a preferred embodiment, to highlight a presently selectable displayed selection. Such focus capabilities are many and varied and are otherwise well understood in the art and include but are not limited to an overlying cursor icon, highlighting of the area of focus, use of reverse contrast, or application of a peripheral boundary indicator to visually indicate the area of focus, to name but a few.

Referring again to FIG. 2, a viewer can select 25 (using, for example, a remote control) a given candidate program and the process 20 will respond with transmission 26 of that selection information to a processing unit to permit appropriate processing of and a response to that instruction. Such actions can be effected in a variety of ways. For example, in the illustration of FIG. 5, the characterizing descriptor (or descriptors) as correspond to an Nth candidate program resides within an area of focus 54. In accord with ordinary practice, for example, the viewer can now select this programming option by asserting a corresponding “select” key on, for example, a remote control device. (Selection of a given programming option can result in an immediate display of that particular programming option, a scheduled recording of that programming option, or such other option as may be provided by a given system designer.)

In the alternative, a viewer can also move the area of focus to a new position (for example, by using a key that permits scrolling action of the focus area in accord with prior art practice). As optionally presented in FIG. 2, such a change in the area of focus can be detected 27 by the process 20. In the present embodiment, such a change can represent a vertical change (and hence a change within the realm of available programming options) or a horizontal change (and hence a change to the filter regions). When the process 20 detects 28 that the change (such as a vertical change in this illustration) comprises a change in the pre-selection of a program, the process will change 29 the displayed pre-selection and hence change which candidate program is now associated with the area of focus 54.

Such a change can be implemented in various ways. As one example, the area of focus indicia can itself be moved on the display to become associated with a set of characterizing descriptors for a different candidate program. As another example, the candidate program information can be moved on the display (by vertical scrolling, for example) to cause a new set of characterizing descriptors to become associated with the area of focus.

In this embodiment, when the movement of the area of focus does not comprise a change 28 in the pre-selection of a candidate program, as when the area of focus 54 moves to the left and into the second display region 42, the process 20 provides for the pre-selection 30 of the filter criterion 52 for the second filter. In addition, the process 14 also provides for the automatic display of a plurality of presently un-selected but user-selectable characterizing descriptor filter criteria for this second filter. FIG. 6 illustrates such an action, where the area of focus 54 how highlights a presently selected second filter criterion 52 and where other filter criteria 61 for the second filter are also automatically displayed. (It will be noted that, in a preferred embodiment, only the presently selected filter criterion 51 for the first filter will be displayed notwithstanding the display of other options for the second filter. It would of course be possible, if desired, to also now automatically display all filter criteria for the first filter as well.)

At this point, the viewer can still view the filtered results on this display and can also still clearly perceive the specific filter criteria that govern this selection of a particular subset of candidate programs. In addition, however, as the viewer has now evinced an intent or interest in altering the filter criteria, the viewer can also clearly see various other selectable filter criteria that are available for use in changing the filtering of the available programming options. Intuitive use of system navigation tools (such as arrow keys or other cursor/area of focus movement mechanisms as may be provided in a given embodiment) invite the viewer to move upwardly or downwardly in the list of filter criteria for the second filter to explore and/or select such different filtering criterion.

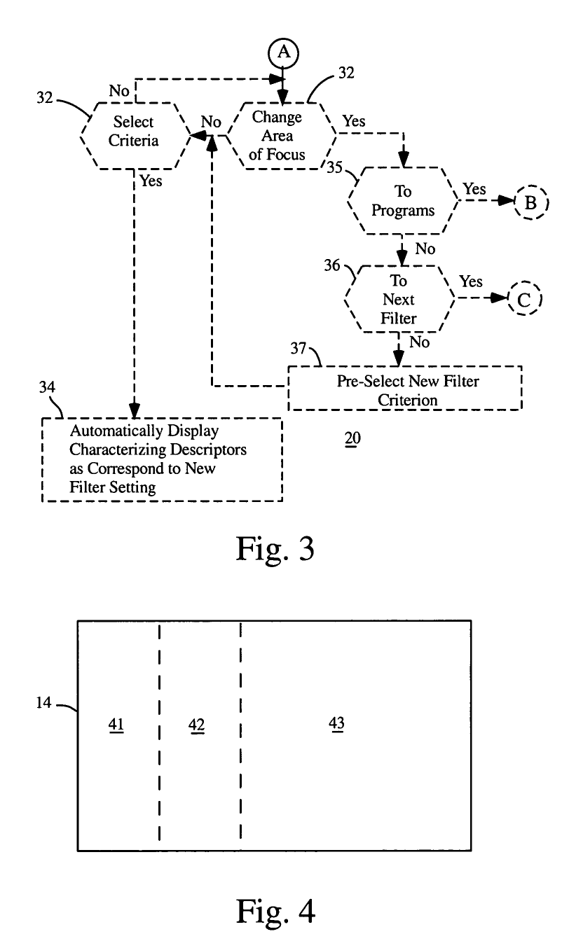

Referring now to FIG. 3, when the viewer effects such vertical movement, the process 20 can detect 32 such movement and then monitor 33 for selection of a new filter criterion. When such a selection occurs, the process can automatically display 34 at least a portion of the characterizing descriptors as corresponds to the newly selected user-selectable characterizing filter criterion for the second filter and the present setting for the first filter. The latter results are preferably displayed in the third region 43 of the display in substitution of the candidate program results as were earlier so-provided.

So configured, the viewer receives immediate results and feedback regarding the effect of making a change to the second filter. At the same time, the viewer continues to have clear and ready insight regarding the present filter criteria settings. This combination of information and steps can serve well to maintain an informed sense of cause and effect and further serves to reinforce the relatively intuitive use and navigation of this interface.

It is also possible that, instead of immediately selecting a presently highlighted filter criterion, the viewer will instead navigate within the display by again changing the area of focus. Upon detecting 32 such a change to the area of focus, the process 20 can determine 35 whether the viewer has moved the area of focus back to the candidate program display region 43 of the display 14. When true, the process 20 can continue in relevant fashion as described above.

When the viewer has not moved the area of focus back to the candidate program region 43, the process 20 can determine 36 whether the viewer has moved the area of focus to the first filter region 41. When true, the process 20 can then proceed as described above to detect both navigation and selection actions. In particular, and referring now momentarily to FIG. 7, upon moving the area of focus from the second filter region 42 to the first filter region 41, the display reverts to displaying only the presently selected filter criterion 52 for the second filter. In addition, and as before, available candidate filter criteria 71 for the first filter are now displayed. The viewer can now again use the area of focus 54 paradigm to pre-select and to select a given candidate filter criterion for the first filter.

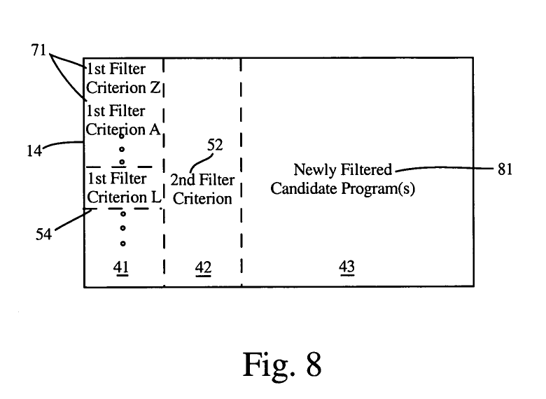

Such navigation can be realized in a variety of ways as noted above. As one illustration, and referring momentarily to FIG. 8, when signaling upward movement, the area of focus 54 can remain essentially stationary with respect to the display 14 while the list of filter criteria scrolls downwardly to associate a next adjacent filter criterion with the area of focus. This association establishes the pre-selection of that particular filter criterion. By then asserting a “select” command, the viewer can then select and establish that particular filter criterion as the filter criterion that is utilized when developing a newly filtered displayed list of candidate programs 81. In particular, and referring again to FIG. 3, upon detecting 37 the pre-selection of a new filter criterion, the process 20 can then detect 33 whether the viewer then selects that pre-selected filter criterion (which results in filtering and display actions as described above) or effects 32 yet another change with respect to the area of focus.

In the illustrated embodiments, it may be possible that there are more available candidate programs and/or filter criteria than can be reasonably be displayed at a single time. In such an event, a viewer can move or scroll the area of focus in a vertical direction to cause additional presently undisplayed information to become displayed. Such new information can be scrolled one-by-one onto the display or can be replaced in bulk (on a page-by-page basis, for example) as desired.

It is possible, of course, that additional filters may be available for use by the viewer. Depending upon the perceived needs of the application, it may be desirable to display such additional filters and their corresponding filter criterion on the display 14 by adding, for example, additional corresponding areas of display. In the alternative, or in addition to the above approach, it may also be possible to make such additional filters/criterion available by permitting the viewer to scroll off-display in the horizontal direction to effect the display of such filters/criterion.

It can therefore be seen that a viewer can navigate a large number of programming options in a highly intuitive fashion (making use of only a few basic and intuitive commands). This navigation includes easy reliance upon and access to filter criteria that in turn controls the subset of programming options that are presented for consideration and navigation. These benefits are realized without the need to access nested menus. These benefits remain essentially intact even though one scales the information set upwardly to include a relatively large body of data for any or all of the programming options and/or the filters and their filter criteria.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one illustrative example, the areas of display 41, 42, and 43 that segregate the display 14 into separate areas for displaying the filter criterion and the characterizing descriptors for the programming options can be horizontally oriented with respect to one another rather than being vertically configured.

1. A method comprising:
providing access to characterizing descriptors as individually correspond to a plurality of discrete selectable items of audio/visual content;
providing a first characterizing descriptor filter;
providing a second characterizing descriptor filter;
simultaneously displaying:
a first selected user-selectable characterizing descriptor filter criterion as corresponds to a present setting of the first characterizing descriptor filter;
a second selected user-selectable characterizing descriptor filter criterion as corresponds to a present setting of the second characterizing descriptor filter;
at least a portion of the characterizing descriptors as corresponds to a present setting of the first and second plurality of user-selectable characterizing descriptor filter criteria.

2. The method of claim 1 wherein displaying at least a portion of the characterizing descriptors as corresponds to a present setting of the first and second plurality of user-selectable characterizing descriptor filter criteria further comprises not displaying any of the characterizing descriptors as do not correspond to the present setting of the first and second plurality of user-selectable characterizing descriptor filter criteria.

3. The method of claim 1 wherein providing access to characterizing descriptors as individually correspond to a plurality of discrete selectable items of audio/visual content further comprises providing access to textual characterizing descriptors as individually correspond to the plurality of discrete selectable items of audio/visual content.

4. The method of claim 3 wherein providing access to characterizing descriptors as individually correspond to a plurality of discrete selectable items of audio/visual content further comprises providing access to characterizing descriptors that comprise at least one of:
a programming network identifier;
a broadcast starting time;
a description of the audio/video content;
content media source.

5. The method of claim 3 wherein the plurality of discrete selectable items of audio/visual content are embodied in a plurality of media.

6. The method of claim 3 further comprising simultaneously displaying a program of audio/visual content.

7. The method of claim 3 further comprising simultaneously displaying a preview of a discrete selectable item of audio/visual content as corresponds to a present setting of the first and second plurality of user-definable characterizing descriptor filter criteria.

8. The method of claim 7 wherein the preview of a discrete selectable item of audio/visual content as corresponds to a present setting of the first and second plurality of user-definable characterizing descriptor filter criteria is displayed as a background image.

9. The method of claim 7 wherein the preview of a discrete selectable item of audio/visual content as corresponds to a present setting of the first and second plurality of user-definable characterizing descriptor filter criteria is displayed as a windowed segregated image.

10. The method of claim 3 further comprising:
selecting at least one of the plurality of discrete selectable items of audio/visual content as corresponds to the present setting of the first and second plurality of user-selectable characterizing descriptor filter criteria;
transmitting a signal to an audio/visual display device indicating the selection of the at least one of the plurality of discrete selectable items of audio/visual content as corresponds to the present setting of the first and second plurality of user-selectable characterizing descriptor filter criteria.

11. The method of claim 1 wherein the present setting of the first and second plurality of user-selectable characterizing descriptor filter criteria is selected in response to a remote control device.

12. The method of claim 1 wherein the present setting of the first and second plurality of user-selectable characterizing descriptor filter criteria is selected in response to a remote control device by scrolling through candidate settings of the first and second plurality of user-selectable characterizing descriptor filter criteria.

13. The method of claim 1 wherein:
displaying a first selected user-selectable characterizing descriptor filter criterion as corresponds to a present setting of the first characterizing descriptor filter further comprises displaying only the first selected user-selectable characterizing descriptor filter criterion; and
displaying a second selected user-selectable characterizing descriptor filter criterion as corresponds to a present setting of the second characterizing descriptor filter further comprises displaying only the second selected user-selectable characterizing descriptor filter criterion.

14. The method of claim 13 and further comprising:
at least pre-selecting the first selected user-selectable characterizing descriptor filter criterion;
automatically displaying a plurality of selectable user-selectable characterizing descriptor filter criteria for the first characterizing descriptor filter.

15. The method of claim 14 and further comprising:
detecting selection of one of the plurality of selectable user-selectable characterizing descriptor filter criteria for the first characterizing descriptor filter to thereby provide a new selected user-selectable characterizing descriptor filter criterion for the first characterizing descriptor filter;
automatically displaying at least a portion of the characterizing descriptors as corresponds to the new selected user-selectable characterizing descriptor filter criterion and the present setting of the second plurality of user-selectable characterizing descriptor filter criteria.

16. An interactive data display system comprising:
characterizing descriptors as individually correspond to a plurality of discrete selectable items of data;
at least a first and a second characterizing descriptor filter;
control circuitry that simultaneously displays:
at least one of a first plurality of user-selectable characterizing descriptor filter criteria as corresponds to the first characterizing descriptor filter;
at least one of a second plurality of user-selectable characterizing descriptor filter criteria as corresponds to the second characterizing descriptor filter;
at least a portion of the characterizing descriptors as corresponds to a present setting of the first and second plurality of user-selectable characterizing descriptor filter criteria.

17. The interactive data display system of claim 16 further comprising:
a remote control device for at least pre-selecting the present setting of either of the first and second plurality of user-selectable characterizing descriptor filter criteria.

18. The interactive data display system of claim 17 wherein said remote control device comprises at least one key for scrolling through candidate settings of the first and second plurality of user-selectable characterizing descriptor filter criteria.

19. The interactive data display system of claim 18 wherein the remote control device further comprises at least one key for moving an area of focus from one user-selectable characterizing descriptor filter criterion to another user-selectable characterizing descriptor filter criterion.

20. The interactive data display system of claim 16 further comprising:
a remote control device for selecting the present setting of the first and second plurality of user-selectable characterizing descriptor filter criteria.

21. The interactive data display system of claim 20 wherein the remote control device comprises at least one key for scrolling through candidate settings of the first and second plurality of user-selectable characterizing descriptor filter criteria.

22. The interactive data display system of claim 21 wherein the remote control device further comprises at least one key for moving an area of focus from one user-selectable characterizing descriptor filter criterion to another user-selectable characterizing descriptor filter criterion.

23. The interactive data display system of claim 16 further comprising control circuitry that simultaneously displays a program of audio/visual content.

24. The interactive data display system of claim 16 further comprising control circuitry that simultaneously displays a preview of a discrete selectable item of audio/visual content as corresponds to a present setting of the first and second plurality of user-definable characterizing descriptor filter criteria.

25. The interactive data display system of claim 24 wherein the preview is displayed as a background image.
